(19) United States
(12) Patent Application Publication
(10) Pub. No.: US 2002/0022947 A1
(43) Pub. Date: Feb. 21, 2002

(54) Simulator, method and recording medium for simulating a biological system

(76) Inventor: Hiroyuki Kurata, Iizuka (JP)

Correspondence Address: Oliff & Berridge PLC, P.O. Box 19928, Alexandria, VA, 22320, US

(21) Appl. No.: 09/727,699

(22) Filed: Dec. 4, 2000

(30) Foreign Application Priority Data
Jul. 4, 2000 (JP) 2000-106295

(51) Int. Cl. G06F 17/10

(52) U.S. Cl. 703/2

(57) ABSTRACT

A novel simulator, simulation method, and recording media are presented in order to correctly simulate a large-scale and complex molecular process in a biological system at a higher speed than any other proposed method. This method divides a biological system, which can be described by chemical reaction formulas, into two phases: the binding and reaction phases, which the inventor names the two-phase partition method.

### BACKGROUND OF THE INVENTION

1. Field of the Invention

The present invention relates to a simulator, a simulation method and a recording medium for simulating a biological system at a molecular interaction level.

2. Description of the Related Art

Genome sequencing projects and systematic functional analyses of complete gene sets are producing a mass of molecular information for a wide range of model organisms. This may enable a computer to analyze the whole biological systems at a molecular interaction level, thereby understanding the dynamic behavior of living cells: how all the cellular components function as a living system.

The mathematical model has been elaborately programmed to adjust simulated data to observed ones, which required expertise or experiences regarding mathematical techniques and training. It is not easy for an ordinary experimentalist to get along with such a programmed modeling. The increasing demand for models of biochemical and physiological processes necessitates the development of a comprehensive software suite that excludes all the time-consuming manual operations involved in formulating, debugging and analysis of mathematical models. Various simulators or software packages, such as GEPASI, KINSIM, MIST, MetaModel, SCAMP, E-CELL, and BEST-KIT, have been developed that automatically converted a biological system to a mathematical model without any annoying modeling technique.

Those simulators employ ordinary differential equations to simulate a molecular process, but the problem has been that exact simulation often required a long time of calculation, because there was a huge scale level of the hierarchy regarding the concentrations of cellular components and kinetic parameters. The number of proteins or small molecules within a cell, which depends on the species, was distributed in the wide range over the order of 10⁸. in addition, the difference in the rate constants of reactions including association, dissociation, conversion, and degradation, depending on the kinds of the reactions, can be over the order of 10¹⁰. Such systems requires fine differential time interval, thus causing the calculation time to become too large, restricting the use of ordinary differential equations.

Various formalisms such as the Michaelis-Menten equation, the power law formalism, and the conventional mass action equations, have been extensively employed for simulating a biological system that is composed of a mass of various chemical reactions such as conversion, synthesis, degradation, transportation, and binding. The important thing is that all the reactions can be expressed with a combination of a simple chemical reaction formula as follows:

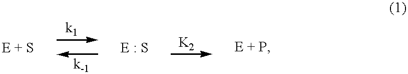

where S is the substrate, P the product, and S:E the complex. The kinetic parameter k₁ is the association rate constant, k₋₁ the dissociation rate constant, and k₂ the reaction rate constant. we characterized the advantages and disadvantage of the above formalisms for simulating a biological system.

(1) The Michaelis-Menten Equation

Generally, Eq. (1) is converted by using the Michaelis-Menten equation under the assumption that the concentration of the complex [E:S] keeps at a steady state and [E]<<[S] as follows:

$$\frac{ⅆ V}{ⅆ t} = \frac{{V}_{max} [ S ]}{{K}_{m} + [ S ]} , \qquad ( 2 )$$

Vₘₐₓ=k₂[Eₜₒₜ] (3),

where the maximum reaction rate Vₘₐₓ and the Michaelis constant Kₘ can be measured experimentally. The problem is that the complex concentration [E:S] is cancelled. In a biological system including protein signal transduction, the chains of interactions among the proteins and DNAs are very long because the components are directly or indirectly interacted through their complexes. Therefore, exact simulation should consider the complex concentrations. The Michaelis-Menten equations are remarkably useful for the study of isolated reaction mechanisms, but they are often highly inappropriate for the study of integrated biochemical systems in vivo because of the neglect of the complex concentrations. The assumptions ([E]<<[S]) of the Michaelis-Menten formalism are also violated by enzyme-enzyme interactions, suggesting that there are problems in using this formalism to characterize the protein signal transduction within integrated biochemical systems.

(2) Power Law Formalism

To simulate a large scale of complex biochemical interaction networks instead of the Michaelis-Menten equations, the power law formalism that can include the effects of all the components within a cell has been applied in which the rates of reactions are described by products of power-law functions. The power law formalism provides the context for assessing the importance of fractal kinetics in the quantitative characterization. This formalism was demonstrated to well characterize the large-scale metabolism of the Tricarboxylic acid cycle of Dictyostelium discoideum. Although the power law formalism accurately represented the macroscopic behavior of large numbers of molecules such as metabolites, the behavior of a small numbers of molecules such as proteins and DNAs is poorly represented. Therefore, it seems not to be applied to signal transduction pathways involving enzymes and DNAs interactions.

(3) Conventional Mass Action Equation

The chemical reaction equation of Eq. (1) is expanded into ordinary differential equations using the rate for binding between enzyme and substrate, k₁, the rate for dissociation of the enzyme-substrate complex, k₋₁, and the rate for forming the product, k₂, as follows.

$$\begin{matrix}\frac{ⅆ [ E ]}{ⅆ t} = - {k}_{1} [ E ] [ S ] + {k}_{- 1} [ E : S ] & ( 4 ) \\ \frac{ⅆ [ S ]}{ⅆ t} = - {k}_{1} [ E ] [ S ] + {k}_{- 1} [ E : S ] & ( 5 ) \\ \frac{ⅆ [ E : S ]}{ⅆ t} = {k}_{1} [ E ] [ S ] + {k}_{- 1} [ E : S ] - {k}_{2} [ E : S ] & ( 6 ) \\ \frac{ⅆ [ P ]}{ⅆ t} = {k}_{2} [ E : S ] & ( 7 )\end{matrix}$$

This ordinary expansion is known as one of S-system methods This method is able to correctly consider all the molecular interactions and seers to be one of the best or most general ways to describe a complex biological system, but there is a serious weakness. The problem is that it takes a long time for differential equations to calculate a biochemical reaction network where there is a huge difference in the values of biochemical parameters. Such a huge difference greatly decreases the differential time interval for numerical calculation, causing the calculation time to become remarkably long. The use of modern super computers never solves this problem.

### SUMMARY OF THE INVENTION

The object of the present invention is to overcome the problems regarding the accuracy and calculation speed involved in the traditional simulation methods. Concretely speaking, the object is to present a simulator, a simulation method, and a recording medium that enforces simulation of large-scale and interactive molecular networks at an extremely high speed.

According to the present invention, there are provided a simulator, and a simulation method for simulating a molecular process of a biological system, which comprise the steps for: partitioning enzyme reaction formulas into the binding phase where an enzyme [E] binds to a substrate [S] to forma complex [E:S], and the reaction phase where the complex [E:S] is reacted to produce a product [P]; applying numerical formula conversion processing to the binding phase; applying numerical formula conversion processing to the reaction phase; calculating the binding phase using the converted numerical equations; calculating the reaction phase using the converted numerical equations.

In the step for applying numerical formula conversion processing to the binding phase, the simulator, the simulation method comprise the steps for: automatically generating simultaneous algebraic equations with a binding association constant Kb; automatically generating a mass balance equation for each basic component that cannot be divided any more.

In the step for applying numerical formula conversion processing to the reaction phase, the simulator and the simulation method comprise the step for describing the reaction phase with differential equation.

Under the condition that the substrate concentration [S] is much higher than enzyme [E], e.g., the reactions of metabolites such as amino acids and organic acids, the enzyme reaction formula is not partitioned into the binding and reaction phases, but expanded to the Michaelis-Menten equations.

When a transcription-translation rate equation is derived from the chemical reaction formula for expressing that a gene is transcripted into a mRNA and the mRNA is translated into a protein, the simulator and the simulation method comprise the steps for; extracting the chemical reaction equations involving protein synthesis and degradation out of the reaction phase to add the equations to the transcription-translation rate equations; assigning all the transcription-translation equations to the reaction phase.

According to the present invention, the simulator and the simulation method comprise: the input part for receiving chemical reaction formulas; the part for partitioning the enzyme reaction formulas into the biding phase where an enzyme [E] binds to a substrate [S] to form a complex [E:S], and the reaction phase where the complex [E:S] is reacted to produce a product [P]; the part of applying numerical formula conversion processing to the binding phase in order to generate simultaneous algebraic equations; the part of applying numerical formula conversion processing to the reaction phase in order to generate differential equations; the execution part for simulating the binding and reaction phases based on the converted equations; the output part for the result of simulation.

According to the present invention, computer-readable media for recording the programs that enforce the simulation of a biological system comprise the steps for: partitioning the enzyme reaction formulas into the biding phase where an enzyme [E] binds to a substrate [S] to form a complex [E:S], and the reaction phase where the complex [E:S] is reacted to produce a product [P]; applying numerical formula conversion processing to the binding phase in order to generate simultaneous algebraic equations; applying numerical formula conversion processing to the reaction phase in order to generate differential equations; simulating the binding phase based on the converted equations; simulating the reaction phase based on the converted equations;

The recording media include floppy disks, hard drives, magnetic tapes, MO disks, CD-ROMs, DVDs, ROM cartridges, ROM cartridges, flash memory cartridges, nonvolatile cartridges. The recording media also contain cable broadcasting communication media including telephone lines, radio communication media including microwave lines, and the Internet.

The recording medium is defined as material in which the information including digital data and programs is recorded using physical methods and can be downloaded by computers to execute a specific function.

### BRIEF DESCRIPTION OF THE DRAWINGS

FIG. 1: A functional block diagram of a biosimulator according to an embodiment of the present invention.

FIG. 2: A flowchart showing the processing of the system/method according to the present invention.

FIG. 3: A detailed flowchart that explains a part of the flowchart shown in FIG. 2.

FIG. 4: A detailed flowchart that explains a part of the flowchart shown in FIG. 2.

FIG. 5: A detailed flowchart that explains a part of the flowchart shown in FIG. 2.

### DESCRIPTION OF THE PREFERRED EMBODIMENTS

First, the process of how chemical reaction formulas are expanded and divided into the two phases is explained concretely. The simulator and the simulation method divide molecular interaction networks into two-phases: the binding phase and reaction phase. The left hand side of Eq. (1) is transferred to the binding phase and the right hand side to the reaction phase as follows:

Binding phase:

[E:S]=K_{b}[E][S] (8)

[Eₜₒₜ]=[E]+[E:S] (9)

[Sₜₒₜ]=[S]+[E:S] (10)

Reaction phase:

$$\frac{ⅆ [ P ]}{ⅆ t} = {k}_{2} [ E : S ] \qquad ( 11 )$$

where [Eₜₒₜ] and [Sₜₒₜ] are the total concentrations of enzyme and substrate, respectively. In the binding phase, the binding constant, K_{b}=k₁/k₋₁, is employed to express the molecular binding process instead of the association/dissociation rate constants (k₁, k₋₁). The binding phase is described by the nonlinear algebraic equations that consist of the binding equations, Eq. (8), and the mass balance. equations for each component, Eq.(9, 10). The reaction phase, Eq. (11), is described by an ordinary differential equation. In the conventional method, a large difference between the values of k₁ and k₋₁ often causes the differential time interval to become too fine, remarkably increasing the calculation time. The present simulation method excludes the parameters of k₁ and k₋₁ from the differential equations by employing the binding constant (K_{b}) to accelerate the calculation speed greatly. When the substrate is a protein, Eq. (12) is added to the translation equation that will be explained in the next paragraph in order to express the decrease in the protein concentration [S].

Protein synthesis involves various components such as RNA polymerase, suppressor/activator proteins, rRNA, mRNA, tRNA, and elongation factors. The synthesis occurs in very complicated manners, which has not been completely elucidated yet. Of course, it such complex processes are well elucidated, the present simulation method can formulate it. However, the detailed description of protein synthesis is not necessary if the simulation aims at elucidating global signal transduction pathways (metabolic cycles, stress responses). In such cases, the chemical reaction equation expressing protein synthesis is simplified as follows:

$$\begin{matrix}{GENE}_{gene ( i )} {\to }^{transcripition} {mRNA}_{mRna ( i )} {\to }^{deg radation} , \\ & ( 12 ) \\ {mRNA}_{mRna ( i )} {\to }^{translation} {protein}_{P ( i )} {\to }^{deg radation} . & ( 13 )\end{matrix}$$

For transcription, the concentration of mRNA(i) is given by:

$$\frac{ⅆ [ mRNA ( i ) ]}{ⅆ t} = {k}_{m} ( i ) - η ( i ) \cdot [ gene ( i ) ] - k$$

where kₘ(i) and k_{md}(i) are the transcription and degradation rate constants of mRNA(i), respectively, and (i) is the transcription efficiency. The kinetic constant kₓ(j) is the rate constant for the degradation or export/import of mRNA(j) that is caused through the interaction with the component C(j). For translation, the concentration of the protein including modified (phosphorylated, adenylylated. etc) ones, the concentration of P(i) is written as follows:

$$\begin{matrix}\frac{ⅆ [ P ( i ) ]}{ⅆ t} = {k}_{p} ( i ) \cdot ϕ ( i ) \cdot [ mRNA ( i ) ] ⌊ P ( i ) ⌋ \\ = {k}_{dp} ( i ) \\ = {\sum }_{j} {k}_{y} ( j ) [ P ( i ) : C ( j ) ] ,\end{matrix} \qquad ( 15 )$$

where kₚ(i) and k_{dp}(i) are the translation and degradation rate constants of protein P(i), respectively, and (i) is the translation initiation rate. The kinetic rate k_{y}(j) is the rate constants for the degradation or import/export of P(i) that is caused through the interaction with the component C(j).

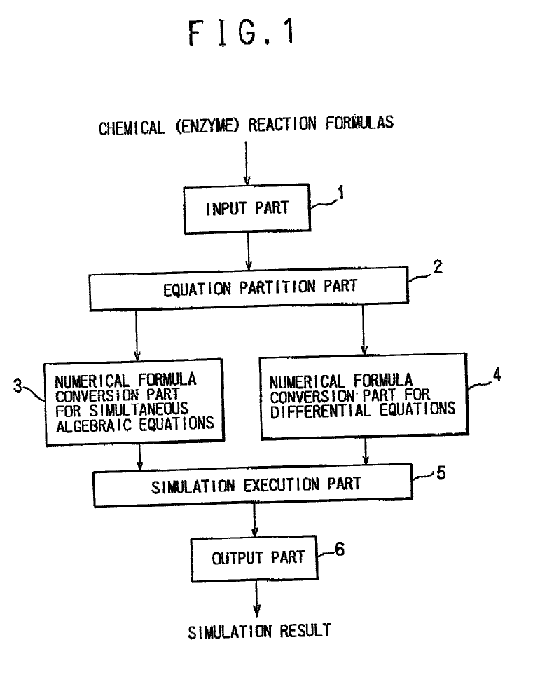

Referring to FIG. 1, simulation is carried out as follows. In the input part [1], the chemical and/or enzyme reaction formulas that express molecular networks are input and transferred to the formula partition part. In the partition part [2], the chemical reaction formulas (Eq. (1)) are partitioned into the binding and reaction phases. The left hand side of Eq. (1) is transferred to the part of numerical formula conversion for simultaneous algebraic equations [3] that express the binding phase, and the right hand side to the part of numerical formula conversion for differential equations [4] that express the reaction phase. In the part [3], the given formulas are converted so as to solve with ordinary algorithms such as the Newton-Raphson method. In the part [4], the given formulas are also converted so as to solve with ordinary algorithms such as the Runge-Kutta method. In the execution part of simulation [5], the simulation is executed based on the equations converted in the numerical formula conversion parts [3, 4]. The output part [6] shows the results.

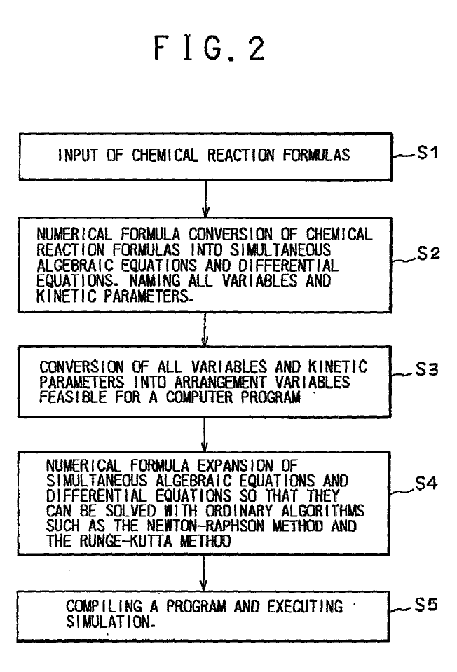

Referring to FIG. 2, following the input of chemical reaction formulas (S1), chemical reaction formulas are numerically converted into simultaneous algebraic equations and differential equations, when all the variables and kinetic parameters are named automatically (S2). Next, all the variables and kinetic parameters are converted into the arrangement variables feasible for a computer program (S3). Simultaneous algebraic equations and differential equations are expanded to solve with ordinary algorithms such as the Newton-Raphson method and the Runge-Kutta method (S4). The expanded equations are converted into a programming-language-readable form to execute the simulation by a computer.

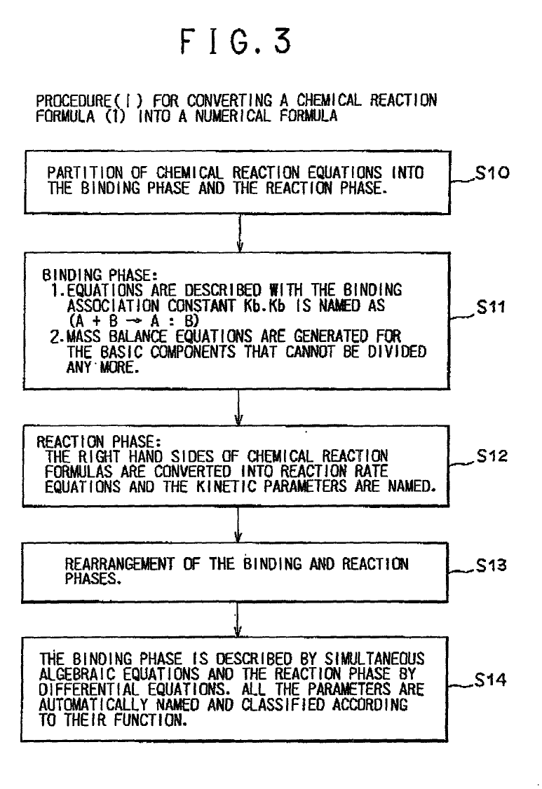

Referring to FIG. 3, in the binding phase (S11), the equations are described with the binding association constants Kb that are automatically named as follows: the binding association constant (A+B→A:B), and mass balance equations are generated for the basic components that cannot be divided any more. In the reaction phase (S12), the right band sides of chemical reaction formulas Eq. (1) are converted into reaction rate equations and the kinetic parameters are named automatically. The biding and reaction phases are rearranged to check whether they express the given network correctly (S13). The binding phase is replaced by simultaneous algebraic equations and the reaction phase by differential equations. All the named parameters are classified according to their function (S14).

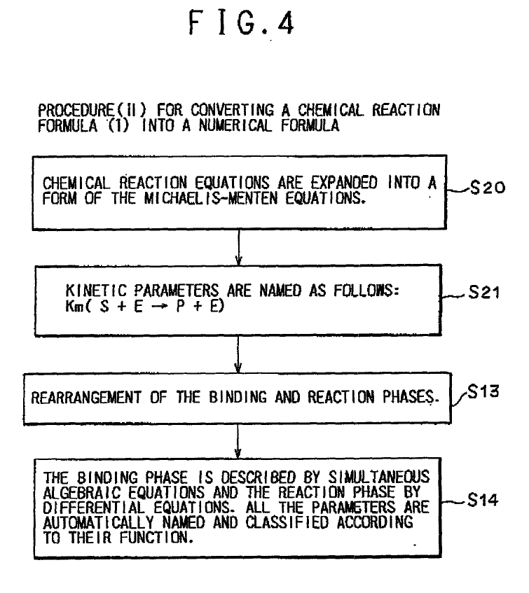

Referring to FIG. 4, when the concentration of the substrate [S] is much higher than the enzyme concentration [E], chemical reaction equations are not applied to the partitioning process, but expanded into the form of the Michaelis-Menten equation (S20). The kinetic parameters are named as follows: Kₘ(S+E→P+E) (S21).

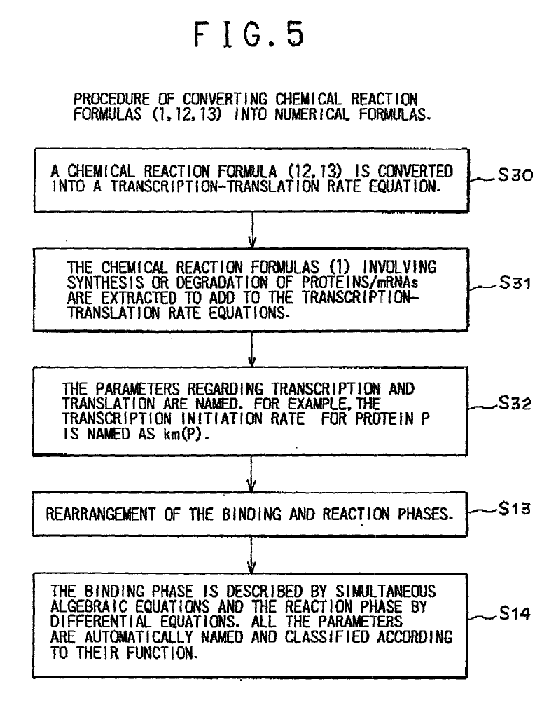

Referring to FIG. 5, chemical reaction formulas (Eqs. (12, 13)) are converted into transcription-translation rate equations (Eqs. (14, 15)) (S30). The chemical reaction formulas Eq. (11) involving synthesis or degradation of proteins/mRNAs are extracted for adding to the transcription-translation rate equations (S31). The, parameters regarding transcription and translation are named automatically. For example, the transcription initiation rate for protein P is named as km(P) (S32).

To calculate the binding phase, simultaneous nonlinear algebraic equations have to be solved, although they are not sure to solve generally. Depending on the scale of the molecular network, the simulator and simulation method are required to solve a large number of simultaneous nonlinear algebraic equations. First, the simultaneous algebraic equations can be converted into differential rate equations by dividing the binding association constant (Kb) into the binding association rate constant (k₁) and the dissociation rate constant (k₁). In order to prevent the calculation time of the differential equations from being too long, the binding and dissociation rates are given small enough. The steady state solutions of such differential rate equations are identical to those of the simultaneous equations. Thus, they are employed as the initial values to solve the simultaneous algebraic equations with the Newton-Raphson algorithm. Finally, the exact solutions are obtained by solving the simultaneous equations repeatedly using the initial values as their solutions, while approaching the binding constant to the target values step by step.

There are many parameters (molecule concentrations, rate constants, binding constants) to adjust the simulation result to the real behaviors of a biological system. Genetic algorithms are applied to such parameter tuning. Genetic algorithm randomly mutates or crossovers large-scale parameter sets to find higher value of the fitness.

The present invention has the following advantages:

1. A large-scale and complicated network is numerically simulated at an extremely high speed.

2. It is easy to modify molecular network system by rewriting a chemical reaction formula.

3. It is feasible to transfer the program to parallel computation, when the program is written by a general language.

4. It is possible to integrate various subsystems into a large-scale system, because the whole system can be described by a collection of chemical reaction formulas.

What is claimed is:

1. A simulation method for partitioning chemical and/or enzyme reaction formulas into two phases: the binding phase where an enzyme [E] binds to a substrate [S] to form a complex [E:S], and the reaction phase where the complex [E:S] is reacted to produce a product [P], comprising the steps for:
applying numerical formula conversion processing to the binding phase;
applying numerical formula conversion processing to the reaction phase;
calculating the binding phase using the converted numerical equations;
calculating the reaction phase using the converted numerical equations.

2. A simulation method as claimed in claim 1, further comprising the steps for:
generating automatically simultaneous algebraic equations with a binding association constant Kb in the step for applying numerical formula conversion processing to the binding phase;
generating automatically a mass balance equation for each basic component that cannot be divided any more in the step for applying numerical formula conversion processing to the binding phase.

3. A simulation method as claimed in claim 1, further comprising the steps fort
generating automatically the reaction phase with differential equations in the step for applying numerical formula conversion processing to the reaction phase.

4. A simulation method as claimed in claim 1 for deriving transcription-translation rate equations from chemical reaction formulas that express that a gene is transcripted into a mRNA and the mRNA is translated into a protein, comprising the steps for:
extracting chemical reaction equations involving protein synthesis and degradation out of the reaction phase and adding the equations to the transcription-translation rate equations;
assigning all the transcription-translation equations to the reaction phase.

5. A simulator comprising:
the input part to receive chemical reaction formulas;
the part for partitioning the enzyme reaction formulas into the biding phase where an enzyme [E] binds to a substrate [S] to form a complex [E:S], and the reaction phase where the complex [E:S] is reacted to produce a product [P];
the part of applying numerical formula conversion processing to the binding phase in order to generate simultaneous algebraic equations;
the part of applying numerical formula conversion processing to the reaction phase in order to generate differential equations;
the execution part for numerically simulating the binding and reaction phases based on the converted equations;
the output part of the result of simulation.

6. computer-readable media recording the programs that enforce the present invention, comprising the steps for:
partitioning the chemical and/or enzyme reaction formulas into the biding phase where an enzyme [E] binds to a substrate [S] to form a complex [E:S], and the reaction phase where the complex [E:S] is reacted to produce a product [P];
applying numerical formula conversion processing to the binding phase in order to generate simultaneous algebraic equations;
applying numerical formula conversion processing to the reaction phase in order to generate differential equations;
simulating the binding phase based on the converted equations;
simulating the reaction phase based on the converted equations.
